(19) United States
(12) Patent Application Publication
(10) Pub. No.: US 2021/0255858 A1
(43) Pub. Date: Aug. 19, 2021

(54) COMPUTATION DEVICE

(71) Applicant: NEC Corporation, Minato-ku, Tokyo (JP)

(72) Inventor: Kei KIMOTO, Tokyo (JP)

(73) Assignee: NEC Corporation, Minato-ku, Tokyo (JP)

(21) Appl. No.: 16/973,961

(22) PCT Filed: Jun. 19, 2019
(86) PCT No.: PCT/JP2019/024351

§ 371 Date: Dec. 10, 2020

(30) Foreign Application Priority Data
Jun. 22, 2018 (JP) 2018-118772

(51) Int. Cl. G06F 9/30

(52) U.S. Cl. CPC G06F 9/3012; G06F 9/30036

(57) ABSTRACT

The purpose of the invention is to reduce the amount of copying of information elements generated when renaming a physical register. With respect to information elements stored in logic registers, this computation device stores, in a third logic register, a third element group that includes information elements representing computation results related to vector operations between portions of a first element group that have a predetermined vector length and portions of a second element group that have a predetermined vector length, the first element group and the second element group being groups of information elements stored in a first logic register and second logic register, respectively. The number of regions in which the information elements can be stored simultaneously and which are provided in the physical registers storing the first element group, the second element group, and the third element group is two or less.

### TECHNICAL FIELD

The present invention relates to a device that executes vector computation.

### BACKGROUND ART

In order to accelerate processing in a core of a central processing unit (CPU), it is effective to increase an instruction issuing rate. As a method for increasing the instruction issuing rate, register renaming has been widely used (see PTLs 2 to 4).

When register renaming is executed, a core includes a larger number of physical registers than the number of physical registers assumed based on a program that causes the core to operate (see PTL 1). When a plurality of instructions to the same physical register are issued by a program, a core uses, when executing these instructions, not only a physical register specified by the program but also another physical register other than the former physical register by rewriting a register name. Thereby, a write-after-read (WAR) dependence relation and a write-after-write (WAW) dependence relation can be resolved or reduced. The WAR dependence relation represents that, until read related to a preceding instruction is completed, it is prohibited to start write related to a subsequent instruction. The WAW dependence relation represents that, until write related to a preceding instruction is completed, it is prohibited to start write related to a subsequent instruction.

In register renaming being commonly executed, a computation device provides another name to a physical register where a certain computation result is written. It is assumed, for example, with regard to a subsequent instruction B that executes write to a logical resource X while an instruction A reads data from the same logical resource X, physical resources X1 and X2 are allocated to the instruction A and the instruction B, respectively, for the logical resource X. In this case, data written by the instruction A can be prevented from deleting due to execution of the instruction B. This indicates that an issuing restriction of the instruction B is relaxed. Therefore, in the case, an instruction issuing rate can be expected to increase.

However, a vector processor commonly includes a mask function of switching presence/absence of calculation with respect to each element. Therefore, there is a problem that, when register renaming is applied to a vector processor, it is difficult to simply achieve register renaming.

As a method being able to solve this problem, PTL 5 discloses a method of renaming a vector register in consideration of masked computation.

### CITATION LIST

### Patent Literature

[PTL 1] Japanese Unexamined Patent Application Publication No. S61-241870
[PTL 2] Japanese Unexamined Patent Application Publication No. 2007-334819
[PTL 3] Japanese Unexamined Patent Application Publication No. 2006-268168
[PTL 4] Japanese Unexamined Patent Application Publication No. 2010-205049
[PTL 5] Japanese Registered Patent Publication No. 6020428
[PTL 6] Japanese Registered Patent Publication No. 6020428
[PTL 7] Japanese Unexamined Patent Application Publication No. H07-234792

### SUMMARY OF INVENTION

### Technical Problem

However, according to a method disclosed in PTL 5, when a core executes processing, based on a program in which many short vector instructions are processed, it is necessary to copy many information elements from a certain physical register to another physical register during register renaming. The operation example is described later in a section of Example Embodiment.

In order to execute copying, it is necessary to read an information element from a storage device or the like. Therefore, in order to execute copying, an input port of a vector register is used. During this period, it is impossible to use, in order to supply data to a computing unit, the input port of the vector register, and thus it is difficult to supply data to the computing unit. As a result, it is difficult to effectively use the computer unit, and therefore, a problem that an operation rate of the computing unit decreases is produced.

An object of the present invention is to provide a computation device and the like capable of reducing an amount of copying of an information element to be generated during renaming of a physical register.

### Solution to Problem

A computation device according to the present invention is a computation device that stores, in a third logic register, a third element group that includes information elements, stored in a logic register, representing a computation result of vector computation between the information elements having a predetermined vector length among a first element group including the information elements stored in a first logic register, and the information elements having the vector length among a second element group including the information elements stored in a second logic register, the computation device including: a first selection unit that inputs each of the information elements having the vector length among the first element group and each of the information elements having the vector length among the second element group to each of physical registers, included in a physical register group, being selected based on first control information; the physical register group that includes the physical registers each storing each of the information elements input from the first selection unit; a second selection unit that inputs each of the information elements input from each of the physical registers storing the information elements input from the first selection unit to each input unit of computing units included in a computing unit group; and the computing unit group that outputs the third element group, based on the vector computation for the information elements input from the second selection unit, wherein the physical register selected based on the first control information is different, depending on a case, between the physical register storing each of the information elements being a target for vector computation before the vector computation, and the physical register storing the information elements representing a computation result of the vector computation for the information elements, and a number of regions, included in each of the physical registers, being able to simultaneously store the information elements is two or less.

### Advantageous Effects of Invention

The computation device and the like according to the present invention are able to reduce an amount of copying of an information element generated during renaming of a physical register.

### BRIEF DESCRIPTION OF DRAWINGS

FIG. 1 is a conceptual diagram illustrating a configuration example of a vector computation system according to the present example embodiment.

FIG. 2 is a conceptual diagram illustrating a configuration example of a computation unit and a storage device.

FIG. 3 is a conceptual diagram illustrating an example of logic register management information.

FIG. 4 is a conceptual diagram illustrating a first example of physical register management information.

FIG. 5 is a conceptual diagram illustrating a second example of physical register management information.

FIG. 6 is a conceptual diagram illustrating an example of reference number information.

FIG. 7 is an illustrative diagram of a first operation example based on a literature method.

FIG. 8 is a diagram illustrating a related portion of physical register management information relevant to an operation described by referring to FIG. 7.

FIG. 9 is an illustrative diagram of an operation example (No. 1) of the present example embodiment relevant to the operation described with reference to FIG. 7.

FIG. 10 is a diagram illustrating a related portion of the physical register management information relevant to an operation described with reference to FIG. 9.

FIG. 11 is an illustrative diagram of an operation example (No. 2) of the present example embodiment relevant to the operation described with reference to FIG. 7.

FIG. 12 is a diagram illustrating a related portion of the physical register management information relevant to an operation described with reference to FIG. 11.

FIG. 13 is an illustrative diagram of a second operation example based on the literature method.

FIG. 14 is a diagram illustrating a related portion of physical register management information relevant to an operation described with reference to FIG. 13.

FIG. 15 is an illustrative diagram of an operation example (No. 1) of the present example embodiment equivalent to the operation described with reference to FIG. 13.

FIG. 16 is a diagram illustrating a related portion of the physical register management information relevant to an operation described with reference to FIG. 15.

FIG. 17 is an illustrative diagram of an operation example (No. 2) of the present example embodiment equivalent to the operation described with reference to FIG. 13.

FIG. 18 is a diagram illustrating a related portion of the physical register management information relevant to an operation described with reference to FIG. 17.

FIG. 19 is an illustrative diagram of an operation example (No. 1) relating to computation where a vector length is six according to the present example embodiment.

FIG. 20 is a diagram illustrating a related portion of the physical register management information relevant to an operation described with reference to FIG. 19.

FIG. 21 is an illustrative diagram of an operation example (No. 2) relating to computation where a vector length is six according to the present example embodiment.

FIG. 22 is a diagram illustrating a related portion of the physical register management information relevant to an operation described by referring to FIG. 21.

FIG. 23 is a diagram illustrating a related portion of logic register management information based on the literature method.

FIG. 24 is a diagram illustrating an example of a related portion of physical register management information based on the literature method relating to a logic register illustrated in FIG. 23.

FIG. 25 is a diagram illustrating a related portion of physical register management information of the present example embodiment corresponding to a portion of logic register management information illustrated in FIG. 23.

FIG. 26 is an illustrative diagram of an operation example based on the literature method, where an element after computation is stored in a physical register that is not referred to in a predetermined vector instruction.

FIG. 27 is a diagram illustrating a related portion of the physical register management information relevant to an operation described with reference to FIG. 26.

FIG. 28 is a block diagram illustrating a minimum configuration of a computation device according to an example embodiment.

### EXAMPLE EMBODIMENT

In a computation device according to the present example embodiment, each physical register includes two or less regions for simultaneously storing information elements.

When each physical register includes two regions, a case where the computation device executes copying in order to maintain an information element is the following case as described below. The case is, in other words, a case where one of two regions included in a physical register stores an information element that is related to computation and the other stores an element that is not related to computation. Therefore, the number of times of copying necessary for maintaining an information element in computation of one time is one or less. When each physical register includes only one region, it is unnecessary to execute copying for maintaining an information element.

In a method described in PTL 5, as described later, in computation of one time, copying may be executed twice or more.

Therefore, the computation device according to the present example embodiment can reduce, compared with the method disclosed in PTL 5, the number of times of copying necessary for maintaining an information element in computation of one time.

### [A Configuration and an Operation]

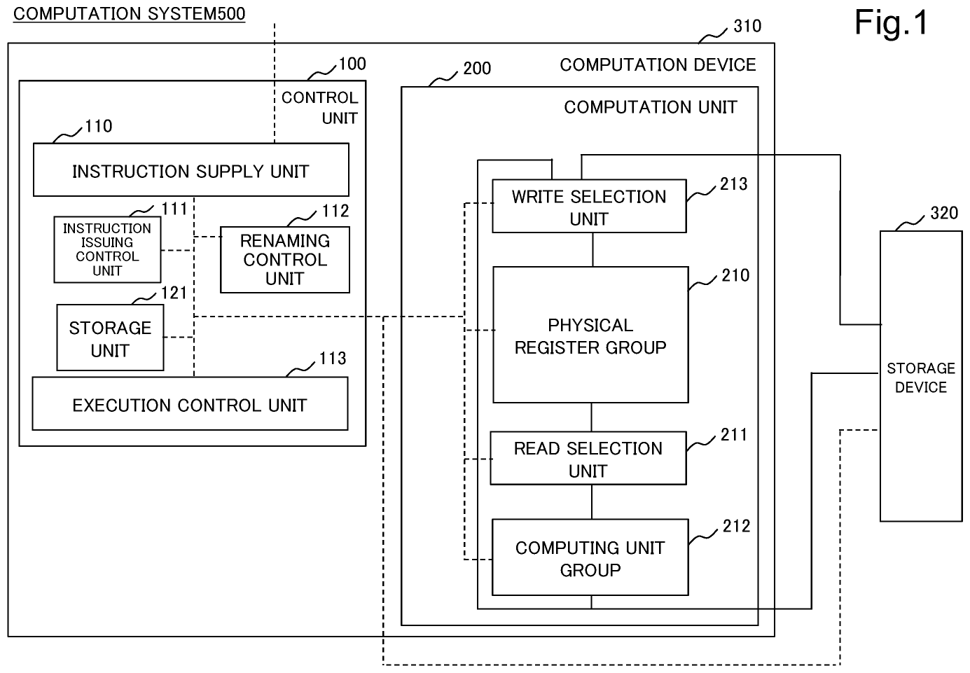

FIG. 1 is a conceptual diagram illustrating a configuration of a computation system 500 which is an example of a vector computation system according to the present example embodiment. A signal line illustrated by a solid line in FIG. 1 is a signal line related to a data signal. A signal line illustrated by a dashed line in FIG. 1 is a signal line related to a control signal.

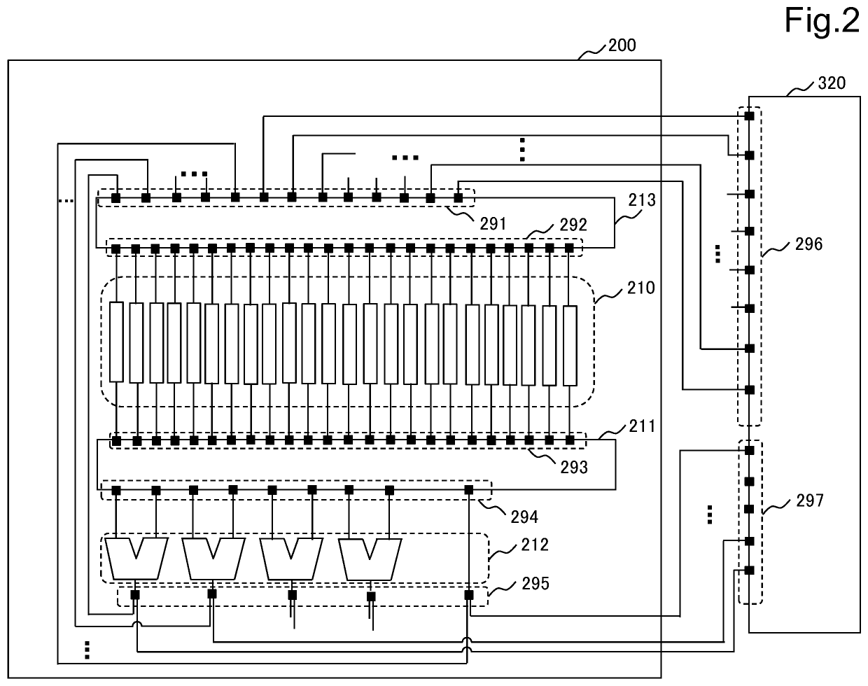

A basic portion of the configuration of the computation system 500 illustrated in FIG. 1 is the same as a configuration described in PTL 5. Therefore, in description of FIG. 1, only an outline portion is described. Description of a portion different from a content described in PTL 5 in the computation system 500 illustrated in FIG. 1 is made in description of FIG. 2 and following figures.

The computation system 500 includes a computation device 310 and a storage device 320.

The storage device 320 is, for example, a main memory of the computation system 500. The storage device 320 stores an information element and the like to be a computation target for vector computation executed by the computation device 310. Herein, it is assumed that an information element is information having a vector length of one, stored in a logic register. An information element includes a computation portion that is a portion used for vector computation and a non-computation portion that is not used for vector computation. In a non-computation portion, for example, an information element related to a computation result of computation executed before certain computation is stored.

In the following, it is assumed that an information element is simply referred to as an “element”. The storage device 320 further stores the element related to a computation result of vector computation executed by the computation device 310.

The computation device 310 is a device such as a processor and the like that processes a vector instruction such as vector load, vector store, vector computation, and the like.

The computation device 310 receives transmission of a vector load instruction from an outside and reads the above-described element from the storage device 320.

The computation device 310 receives transmission of a vector computation instruction from an outside and executes vector computation by using elements read from the storage device 320. The computation device 310 further receives transmission of a vector store instruction from an outside and stores, in the storage device 320, the element representing a computation result.

The computation device 310 includes a control unit 100 and a computation unit 200.

The control unit 100 causes the computation unit 200 and the storage device 320 to execute processing necessary for vector computation.

The control unit 100 includes an instruction supply unit 110, an instruction issuing control unit 111, a renaming control unit 112, an execution control unit 113, and a storage unit 121.

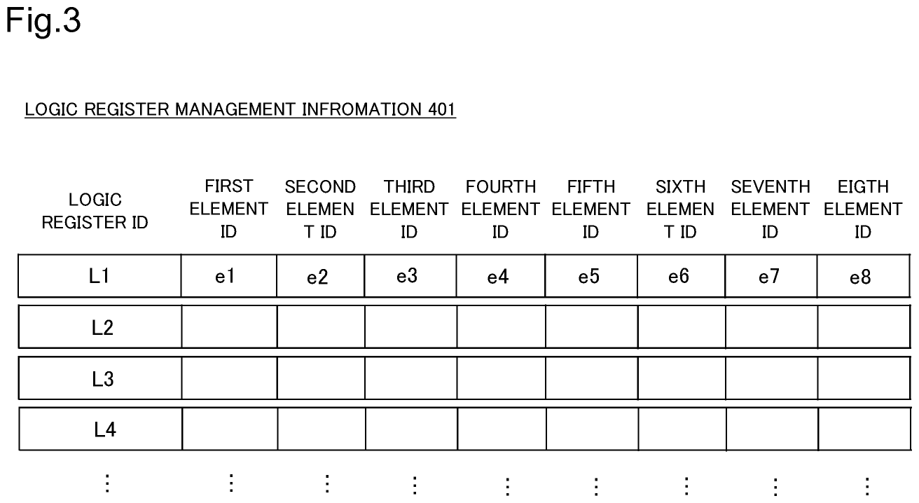

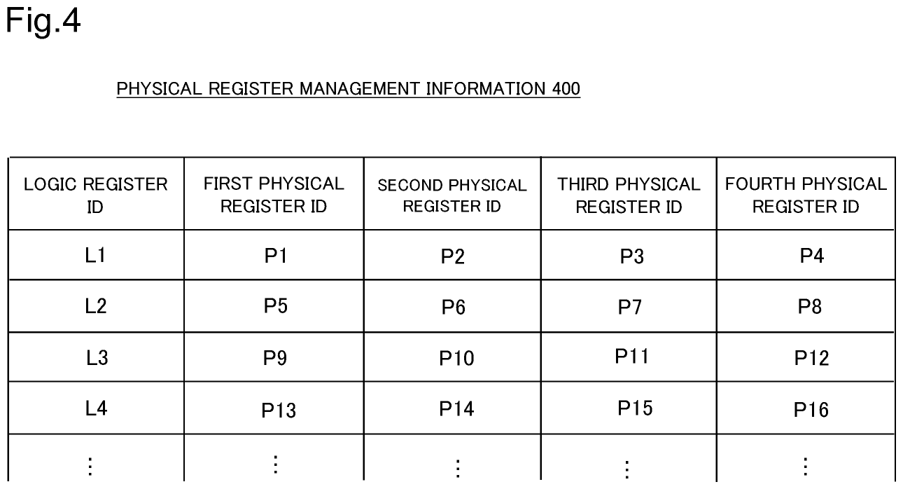

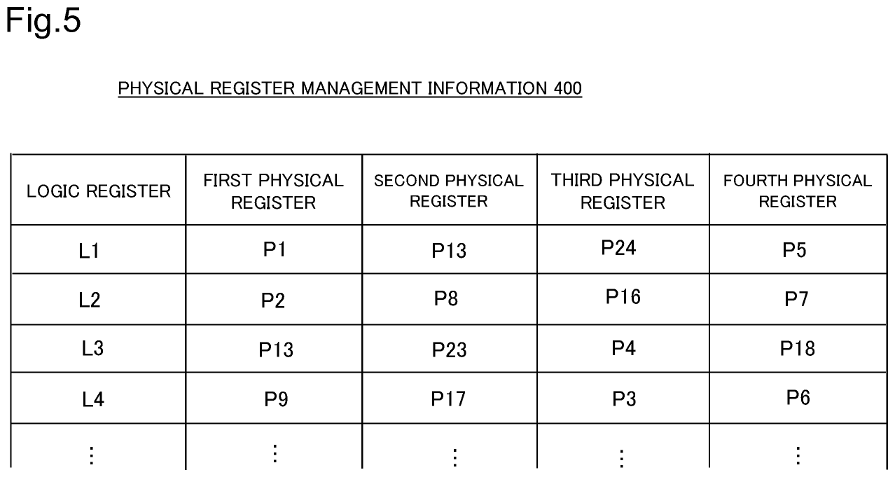

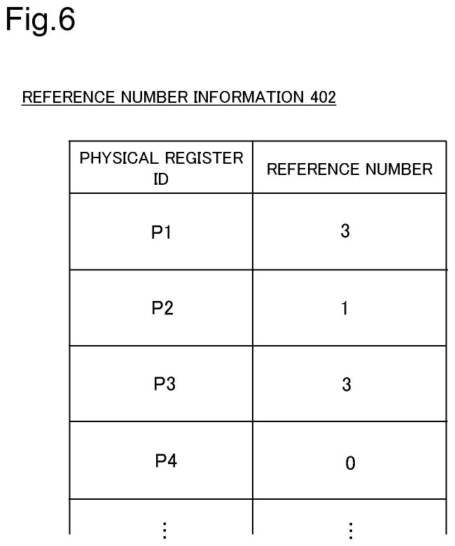

The storage unit 121 stores logic register management information 401 to be described later with reference to FIG. 3, physical register management information 400 to be described later with reference to FIGS. 4 and 5, and reference number information to be described later with reference to FIG. 6. The storage unit 121 stores, other than these pieces of information, information and a program necessary for components of the control unit 100 to execute processing. The storage unit 121 further stores information indicated by components of the control unit 100. The storage unit 121 further transmits indicated storage information in accordance with an instruction from each of the components.

The instruction supply unit 110 receives input information from an outside and generates the above-described vector instruction. The instruction supply unit 110 transmits the generated vector instruction to the instruction issuing control unit 111.

The instruction supply unit 110 further generates a register renaming instruction for indicating renaming of a physical register and transmits the generated instruction to the renaming control unit 112.

When the above-described vector instruction is transmitted from the instruction supply unit 110, the instruction issuing control unit 111 identifies, with respect to logic registers allocated for each vector instruction, physical registers allocated with these logic registers.

When executing the identification, the instruction issuing control unit 111 identifies, from an element group included in the vector instruction transmitted from the instruction supply unit 110, a logic register group allocated with the element group. The instruction issuing control unit 111 executes the identification, based on the element group and logic register management information 401 to be described later with reference to FIG. 3.

Next, the instruction issuing control unit 111 identifies a physical register group to be allocated to the identified logic resister group. The instruction issuing control unit 111 executes the identification, based on physical register management information 400, to be described later with reference to FIGS. 4 and 5, stored in the storage unit 121.

The instruction issuing control unit 111 determines whether storage preparation of the elements is completed in the identified physical registers. The instruction issuing control unit 111 executes the determination, for example, by confirming presence/absence of transmission of a notification signal transmitted from a physical register group 210, representing that storage preparation of the elements is completed. The instruction issuing control unit 111 transmits, when determining that storage preparation of the elements in physical registers allocated to each instruction is completed, notification information to the execution control unit 113.

The execution control unit 113 receives transmission of the notification information from the instruction issuing control unit 111 and generates a control signal in accordance with a vector instruction transmitted from the instruction supply unit 110. The execution control unit 113 transmits the generated control signal to components of the computation unit 200 and the storage device 320.

The control signal generated by the execution control unit 113 includes a write control signal, a read control signal, an input control signal, and an output control signal. A write signal is a control signal transmitted to a write selection unit 213. A read signal is a control signal transmitted to a read selection unit 211. An input control signal and an output control signal are each a control signal transmitted to the storage device 320.

The renaming control unit 112 supplies, when the execution control unit 113 generates a write control signal transmitted to the write selection unit 213, information representing a transmission destination of the element input to the write selection unit 213 specified by the write control signal to the execution control unit 113. The transmission destination is any physical register included in the physical register group 210. At a time of the supply, the renaming control unit 112 refers to physical register management information described above and described later, stored in the storage unit 121.

On the other hand, the output control signal transmitted to the storage device 320 includes information representing the element that the storage device 320 transmits to the computation unit 200. The output control signal transmitted to the storage device 320 further includes information to be stored in the storage device 320, representing the element related to a result of computation performed by the computation unit 200.

Each element related to vector computation executed by the computation unit 200 is input to the write selection unit 213 from the storage device 320 or a computing unit group 212. The element input from the storage device 320 is, for example, an element before computation processing performed by the computation device 310. The element input from the computing unit group 212 is an element related to a result of computation performed by a certain computing unit included in the computing unit group 212.

The write control signal transmitted to the write selection unit 213 represents a transmission destination of each input element. The transmission destination is each physical register of the physical register group 210. The write selection unit 213 switches a physical register being a transmission destination of each input element, in accordance with an input write control signal. Thereby, the element input to the write selection unit 213 is transmitted to a physical register being a transmission destination selected by the write selection unit 213.

The physical register group 210 includes a plurality of physical registers which are not illustrated. When the element is transmitted from the write selection unit 213, each physical register stores the element. Each physical register transmits the stored element to the read selection unit 211 at a predetermined timing.

The read selection unit 211 selects a transmission destination of the element transmitted from each physical register, in accordance with a read control signal transmitted from the execution control unit 113. The transmission destination is an input terminal of an unillustrated computing unit and an unillustrated input terminal for copying, included in the computing unit group 212. Based on these selections, each element stored in a selected physical register is input to a computing unit or wiring for copying included in the computing unit group 212 via the read selection unit 211.

Each computing unit of the computing unit group 212 executes computation for the input element. Each computing unit outputs the element representing a computation result to the write selection unit 213 and the storage device 320.

The storage device 320 stores an element group including the elements. The storage device 320 further outputs, to the write selection unit 213, the element specified by the output instruction. The storage device 320 further stores information that is input from the computation device 310 and is indicated to be stored.

In the following description, unless specifically described otherwise, ease of description is considered and an example of a case where a vector length of a logic register is eight is described. In other words, it is assumed that one logic register stores eight elements. In an actual device, commonly, a vector length of a logic register has a value larger than eight.

FIG. 2 is a conceptual diagram illustrating a configuration example of the computation unit 200 and the storage device 320 illustrated in FIG. 1. Illustration of a signal line for a control signal illustrated by a dashed line in FIG. 1 is omitted in FIG. 2.

FIG. 2 illustrates a configuration example in which vector computation for eight elements or less is executable. In other words, in the configuration example illustrated in FIG. 2, it is assumed that even when all logic registers in which a vector length is eight are included in the above-described computation portion, vector computation is possible.

The computation unit 200 includes, as described in description of FIG. 1, the write selection unit 213, the physical register group 210, the read selection unit 211, and the computing unit group 212.

The write selection unit 213 includes a port group 291 and a port group 292.

First to fifth ports from left belonging to the port group 291 are each connected to each port belonging to a port group 295 of the computing unit group 212. Thereby, when each computing unit belonging to the computing unit group 212 outputs an element representing a computation result to any port belonging to the port group 295, the element is input to a corresponding port belonging to the port group 291.

Sixth to 13th ports from left belonging to the port group 291 are each connected to each port belonging to the port group 296 of the storage device 320. Thereby, when the storage device 320 outputs the element to any port belonging to the port group 291, the element is input to a corresponding port belonging to the port group 291.

The write selection unit 213 connects a predetermined port selected from ports of the port group 291 to a predetermined port selected from the port group 292 at a specified timing in accordance with the write control signal transmitted from the execution control unit 113 illustrated in FIG. 1. The write selection unit 213 may execute a plurality of the connections at one timing.

Ports of the port group 292 are each connected to each physical register belonging to the physical register group 210. Each rectangle in a dashed line representing the physical register group 210 in FIG. 2 represents a physical register. An element output from each port belonging to the port group 292 is stored in each physical register belonging to the physical register group 210.

The number of the elements that can be simultaneously stored in each physical register of the physical register group 210 is two or less. The physical register is a physical vector register when two elements are stored. Superiority in that the number of elements stored in the physical register is two or less is described later.

Each physical register outputs a stored element to a corresponding port belonging to a port group 293 at a timing specified by the execution control unit 113 illustrated in FIG. 1.

The read selection unit 211 connects a predetermined port belonging to the port group 293 to a predetermined port belonging to a port group 294 in accordance with the read control signal transmitted from the execution control unit 113. The read selection unit 211 may execute a plurality of the connections at one timing.

Each computing unit belonging to the computing unit group 212 executes predetermined computation by using two elements input at the same timing from two ports belonging to the port group 294 connected to the computing unit. The computation may be any type. The computing unit outputs the element representing a computation result of the computation to a port connected to the computing unit belonging to the port group 295.

A rightmost side port belonging to the port group 294 is connected, by wiring, to a rightmost side port belonging to the port group 295. Thereby, an element input to the most-right side port belonging to the port group 294 is output to the most-right side port belonging to the port group 295. The wiring is for copying, to a certain physical register, an element output from a certain physical register.

As described above, each port belonging to the port group 295 is connected to each of the first to fifth port from left belonging to the port group 291, respectively. Each port belonging to the port group 295 is further connected to each port belonging to a port group 297 of the storage device 320, respectively.

The storage device 320 stores an element specified by the input signal transmitted from the execution control unit 113 among elements input to the port group 297. The storage device 320 does not store an element that is not specified by the input signal transmitted from the execution control unit 113 among elements input to the port group 297.

FIG. 3 is a conceptual diagram illustrating logic register management information 401 being an example of the above-described logic register management information. FIG. 3 illustrates the logic register management information 401 in a table format.

The logic register management information illustrated in FIG. 3 is well-known logic register management information described also in PTL 5.

A logic register identifier (ID) illustrated in FIG. 3 is information for identifying a logic register. Each of first to eighth element IDs is information for identifying an element stored in an associated position of a logic register.

A logic register is virtual and does not exist, and therefore the element is not actually stored. However, in the following, ease of description is considered and it is assumed that an assumption that an element is stored in a logic register is referred to in such a way that an element is “stored”. The element can be actually stored in a physical register.

In logic register management information 401, each logic register is associated with the stored element.

FIG. 4 is a conceptual diagram illustrating a first example of the above-described physical register management information. FIG. 4 illustrates, physical register management information in a table format.

The physical register management information illustrated in FIG. 4 is unique to the present example embodiment. However, storing and using physical register management information itself is described also in PTL 5 and is well known.

Each of first to fourth physical register IDs illustrated in FIG. 4 is information for identifying a physical register in which an element stored in the position is actually stored.

A reason why in FIG. 4, four physical registers are associated with one logic register is that, herein, it is assumed that two elements are simultaneously stored in one physical register.

In the physical register management information 400, a physical register storing an element stored in each logic register is identified.

FIG. 4 illustrates an example in which as a number included in a logic register ID increases, a number included in a physical register ID simply increases.

When one element is simultaneously stored in one physical register, each logic register is associated with eight physical registers, as described later.

FIG. 5 is a conceptual diagram illustrating a second example of the above-described physical register management information.

Physical register management information 400 illustrated in FIG. 5 is different from the physical register management information 400 illustrated in FIG. 4 in a point that a number included in a physical register relevant to a logic register ID is in random order.

FIG. 6 is a conceptual diagram illustrating reference number information 402 being an example of the above-described reference number information.

Reference number information illustrated in FIG. 6 is also described in, for example, PTL 5 and is well known.

A reference number illustrated in FIG. 6 is a number of times that each physical register ID is referred to in a vector instruction for storing a target element to be computed in a physical register.

A fact that a reference number is zero represents that in a series of computations, a physical register is not used for storing the target element. Therefore, the renaming control unit 112 can allocate, when allocating a physical register ID to a logic register ID, a physical register ID in which a reference number in the reference number information 402 is zero.

Next, an operation example executed by the renaming control unit 112 illustrated in FIG. 1 is described, in comparison with an operation example in which the renaming control unit 112 operates based on a method described in PTL 5. In the following description, it is assumed that the method described in PTL 5 is referred to as a “literature method”.

In the literature method, it is assumed that elements stored in one logic register are stored in two physical registers or less. The number of the elements stored in each physical register is the same as the number of the elements stored in a logic register. Herein, it is assumed that the number of the elements stored in a logic register is eight, as described above. Therefore, the number of the elements stored in each logic register is eight.

In the literature method, in the physical register management information described in description of FIG. 1, further, a physical register ID of a physical register storing an element stored in each logic register is stored. In the physical register management information, further, the number (vector length) of elements stored in a physical register having a first physical register ID is stored.

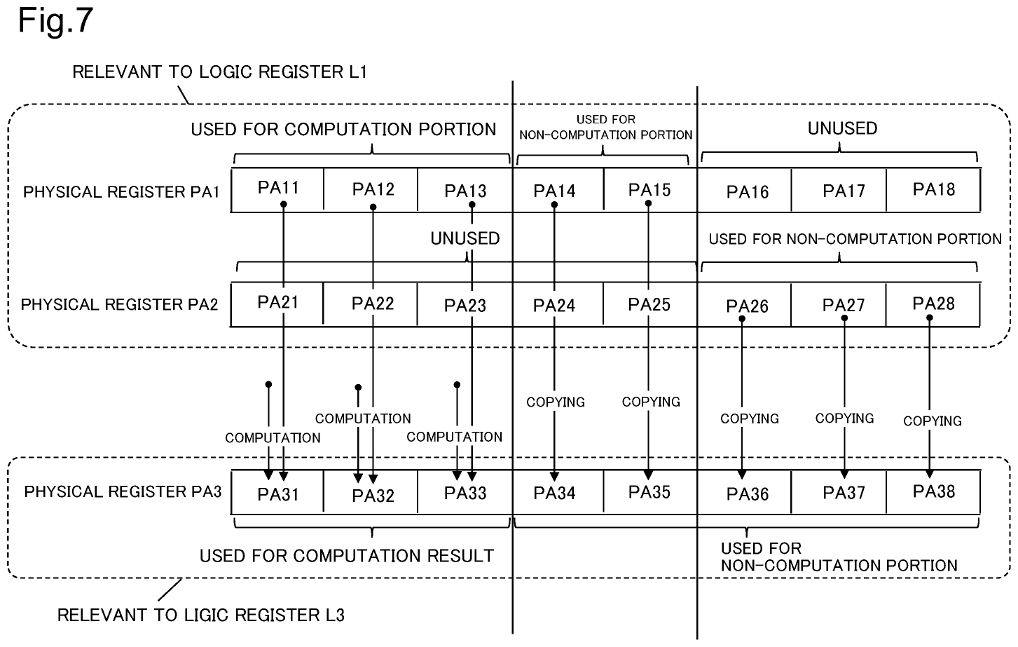

FIG. 7 is a diagram for illustrating a first operation example based on the literature method.

It is assumed that a logic register L1 is a logic register storing elements before execution of vector computation. Herein, it is assumed that the logic register L1 is referred to as a logic register whose logic register ID is L1. Similarly, hereafter, it is assumed that a symbol following a word of a logic register represents a logic register ID of the logic register.

Elements stored in the logic register L1 are separately stored in physical registers PA1 and PA2. Herein, the physical registers PA1 and PA2 are a physical register whose physical register ID is PA1 and a physical register whose physical register ID is PA2, respectively. Similarly, hereafter, it is assumed that a symbol following a word of a physical register represents a physical register ID of the physical register.

Each of regions PA11 to PA18, PA21 to PA28, and PA31 to PA38 in FIG. 7 is a storage region in a physical register capable of storing each element.

In the physical register PA1, elements are stored in the regions PA11 to PA15. The regions PA16 to PA18 are not used for storing an element.

The regions PA11 to PA13 each store a computation portion, being included in an element, which is a portion used for vector computation.

The regions PA14 and PA15 each store a non-computation portion, included in an element, which is a portion that is not used for vector computation. It is assumed that an element stored in each of the regions PA14 and PA15 is an element to be maintained also after computation.

In the physical register PA2, the regions PA21 to PA25 are not used for storing an element. The regions PA26 to PA28 each store a non-computation portion. It is assumed that an element stored in each of the regions PA26 to PA28 is an element to be maintained also after computation.

Herein, it is assumed that the computation device 310 illustrated in FIG. 1 executes computation where a vector length is three for elements stored in the logic register L1, based on an element stored in another logic register which is not illustrated. It is assumed that the computation device 310 executes processing of storing a result of the computation in a logic register L3.

In this case, the computation device 310 executes predetermined computation between an element stored in each of the regions PA11 to PA13 of the physical register PA1 and each of three different elements of a computation portion stored in the above-described another logic register.

The computation device 310 stores a computation result of the computation in each of the regions PA31 to PA33 of the physical register PA3.

The computation device 310 copies an element stored in each of the regions PA14 and PA15 of the physical register PA1 to each of the regions PA34 and PA35 of the physical register PA3. The computation device 310 further copies an element stored in each of the regions PA26 to PA28 of the physical register PA2 to each of the regions PA36 to PA38 of the physical register PA3.

In the operation illustrated in FIG. 7, elements stored in five different regions are copied.

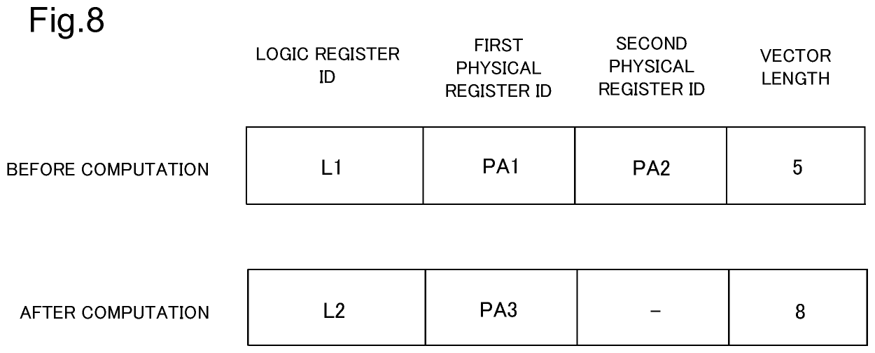

FIG. 8 is a diagram illustrating a related portion of the above-described physical register management information relevant to the operation illustrated in FIG. 7. Illustration of another logic register described in description of FIG. 7 is omitted.

The computation device 310 associates a physical register PA1 as a first physical register and a physical register PA2 as a second physical register with a logic register L1 related to a logic register storing elements before computation. The computation device 310 further associates, as a vector length, five (see FIG. 7) being the number of regions storing elements in the physical register PA1 that is the first physical register with the logic register L1.

In FIG. 8, the computation device 310 associates a physical register PA3 as a first physical register with a logic register L2 storing elements after computation. The computation device 310 further associates, as a vector length, eight (see FIG. 7) being the number of elements stored in the physical register PA3 with the logic register L2.

An operation illustrated in FIG. 7 is executed by the renaming control unit 112 of the computation device 310, based on physical register management information illustrated in FIG. 8.

Next, a case where an operation corresponding to an operation of the operation example illustrated in FIG. 7 is executed by the computation device 310 according to the present example embodiment is described.

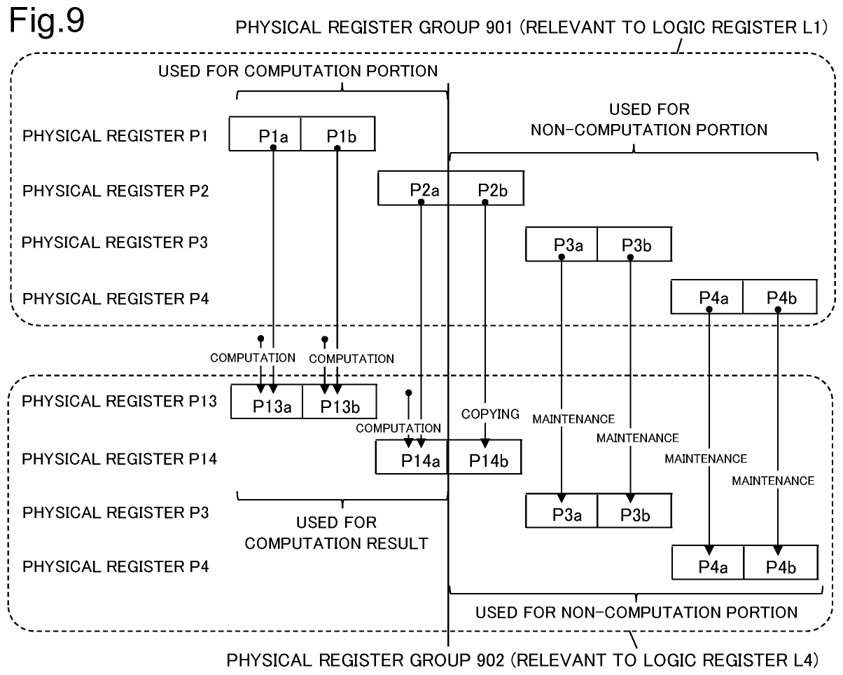

FIG. 9 is a diagram for illustrating an operation example (No. 1) of the present example embodiment corresponding to the operation illustrated in FIG. 7. FIG. 9 illustrates an operation example in which one physical register includes two above-described regions for storing an element.

A physical register group 901 includes physical registers each storing an element stored in a logic register L1.

The physical register group 901 being a physical register group relevant to the logic register L1 includes physical registers P1 to P4. Each physical register includes two regions that are a region assigned with a symbol a following a physical register ID of the physical register and a region assigned with a symbol b following the physical register ID. These regions each can store one element.

In FIG. 7, elements of a computation portion equivalent to elements stored in the regions PA11 to PA13 of the physical register PA1 storing elements before computation are stored in regions of the physical register P1 and a region P2a of the physical register P2 illustrated in FIG. 9.

Elements of a non-computation portion are stored in a region P2b of the physical register P2, regions of the physical register P3, and regions of the physical register P4 illustrated in FIG. 9. It is assumed that these elements of the non-compotation portion are elements to be maintained also after computation. The elements of the non-computation portion are elements equivalent to elements stored in the regions PA14 and PA15 of the physical register PA1 and the regions PA26 to PA28 of the physical register PA2 illustrated in FIG. 7.

A physical register group 902 illustrated in FIG. 9 is relevant to a logic register L4 storing elements after computation.

The physical register group 902 includes physical registers P13, P14, P3 and P4. The physical registers P3 and P4 among these are the same as the physical registers P3 and P4 included in the physical register group 901 storing elements before computation.

Elements of a computation result are stored in regions of the physical register P13 and a region P14a of the physical register P14. Each of the elements is each element representing a computation result of computation in which, on each element of a computation portion before computation, each element of a computation portion stored in another logic register described in illustration of FIG. 7 is computed. Each element of the computation portion before computation is stored in each region of the physical register P1 and the region P2a of the physical register P2 in the physical register group 901.

Elements of a non-computation portion are stored in a region P14b of the physical register P14, regions of the physical register P3, and regions of the physical register P4 belonging to the physical register group 902.

In order to cause elements of a non-computation portion after computation to be the same as elements of a non-computation portion before computation, an element stored in the region P2a of the physical register P2 is copied to the region 14b of the physical register P14.

In order to cause elements of a non-computation portion after computation to be the same as elements of a non-computation portion before computation, elements stored in regions of the physical register P3 and elements stored in regions of the physical register P4 are not output and are maintained as-stored.

In the above-described operation, copying is executed once from a certain region of a physical register to a region of another physical register. However, the number of times of copying necessary for maintaining an element in the operation is once, which is remarkably less than the number of times of copying necessary in the operation illustrated in FIG. 7, which is five times.

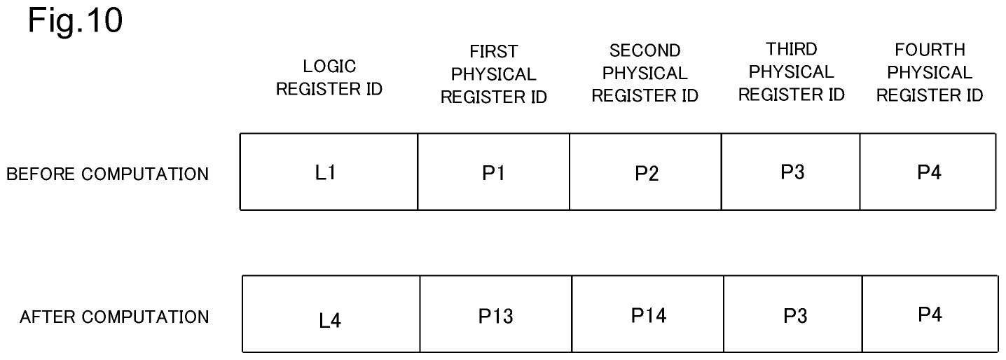

FIG. 10 is a diagram illustrating a related portion of the physical register management information relevant to the operation illustrated in FIG. 9.

The computation device 310 associates the physical registers P1 to P4 with the logic register L1 storing elements before computation.

The computation device 310 further associates the physical registers P13 and P14 and the physical registers P3 and P4 with the logic register L4 storing elements after computation.

In the physical registers P13 and P14, elements related to a computation result are stored, as described with reference to FIG. 9. Therefore, the physical registers P13 and P14 being physical registers different from the physical registers P1 and P2 in which elements before computation have been stored are secured.

In contrast, the physical registers P3 and P4 store, also after computation, an element related to a non-computation portion before computation. Therefore, the physical registers P3 and P4 in which a non-computation portion before computation have been stored are maintained before and after computation while a stored element is not changed.

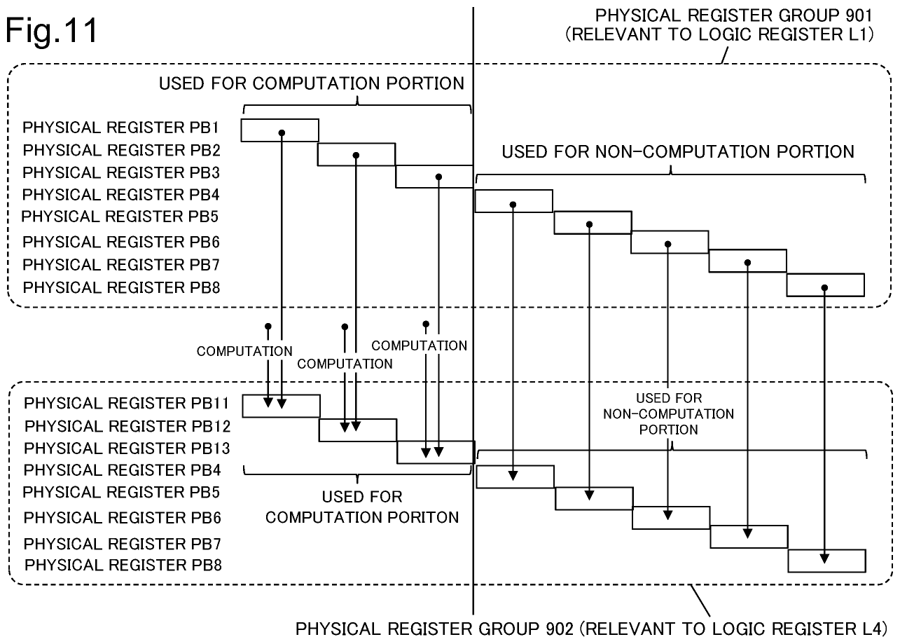

FIG. 11 is a diagram for illustrating an operation example (No. 2) according to the present example embodiment corresponding to the operation illustrated in FIG. 7. FIG. 11 illustrates an operation example in which one physical register includes one region for storing an element.

A physical register group 901 is a physical register group storing elements stored in a logic register L1 being a logic register storing elements before computation.

The physical register group 901 includes physical registers PB1 to PB8. Each physical register includes one region for storing one element.

Elements of a computation portion equivalent to elements stored in the regions PA11 to PA13 of the physical register PA1 being a physical register storing elements before computation in FIG. 7 are stored in physical registers PB1 to PB3 illustrated in FIG. 11.

Elements of a non-computation portion are stored in physical registers PB4 to PB8 illustrated in FIG. 11. Elements of the non-computation portion are equivalent to elements stored in the regions PA14 and PA15 of the physical register PA1 and the regions PA26 to PA28 of the physical registers PA2 illustrated in FIG. 7.

A physical register group 902 illustrated in FIG. 11 is a physical register relevant to a logic register L4 storing elements after computation.

The physical register group 902 includes physical registers PB11 to PB13 and PB4 to PB8. The physical registers PB4 to PB8 among these are the same as the physical registers PB4 to PB8 included in the physical register group 901 storing elements before computation.

The physical registers PB11 to PB13 store elements of a computation result. Each of the elements is each element representing a result of computation executed between each element of a computation portion stored in each of the physical registers PB1 to PB3 in the physical register group 901 and each element of a computation portion stored in another logic register described in description of FIG. 7.

Elements of a non-computation portion are stored in the physical registers PB4 to PB8 belonging to the physical register group 902.

In order to cause elements of a non-computation portion after computation to be the same as elements of a non-computation portion before computation, elements stored in the physical registers PB4 to PB8 in the physical register group 901 are not output from the physical registers and are maintained as-stored.

In the above-described operation, copying from a certain region of a physical register to a region of another physical register for maintaining an element is not executed.

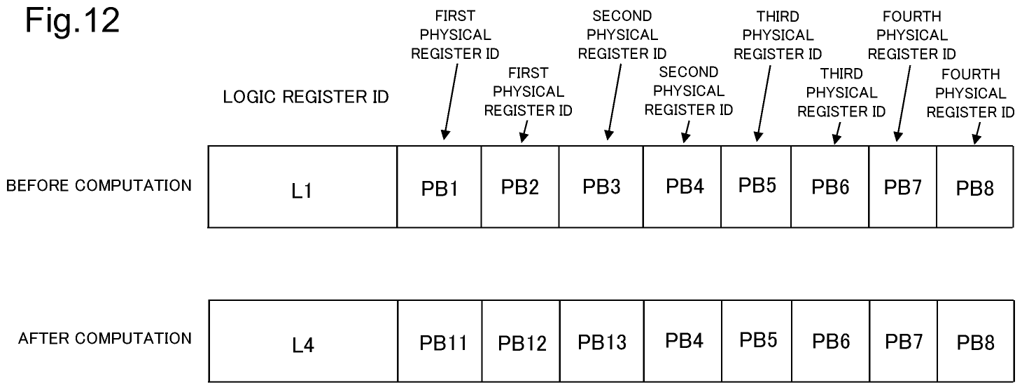

FIG. 12 is a diagram illustrating a related portion of the physical register management information relevant to the operation illustrated in FIG. 11.

The computation device 310 associates the physical registers PB1 to PB8 with the logic register L1 storing elements before computation.

The computation device 310 associates the physical registers PB11 to PB13 and the physical registers PB4 to PB8 with a logic register L4 storing elements after computation.

The physical registers PB11 to PB13 store elements related to a computation result, as described with reference to FIG. 11. Therefore, the computation device 310 allocates the physical registers PB11 to PB13 being physical registers different from the physical registers PB1 to PB3 in which elements before computation have been stored.

On the other hand, the physical registers PB4 to PB8 store elements of a non-computation portion also after computation. Therefore, the computation device 310 does not change elements stored in the physical registers PB4 to PB8 in which a non-computation portion has been stored before computation and maintains the elements before and after computation.

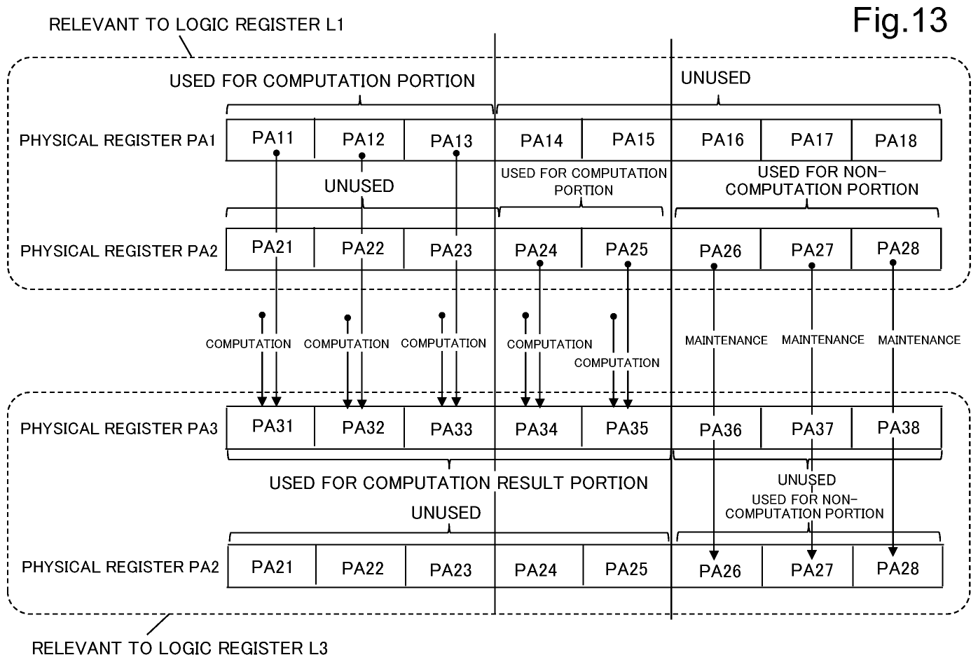

FIG. 13 is a diagram for illustrating a second operation example based on the literature method.

In the present example, elements of a logic register L1 storing elements before computation each are separately stored in each of physical registers PA1 and PA2.

In the present example, regions PA11 to PA13 of the physical register PA1 store elements of a computation portion used for computation. Regions PA14 to PA18 of the physical register PA1 are not used for storing elements.

In the present example, further, regions PA21 to PA23 of the physical register PA2 are not used for storing elements. Regions PA24 and PA25 of the physical register PA2 store elements of a computation portion. Regions PA26 to PA28 of the physical register PA2 store elements of a non-computation portion. It is assumed that these elements of the non-computation portion are elements to be maintained also after computation.

Herein, in the present example, it is assumed that between the logic register L1 and another logic register, computation where a vector length is five is executed.

It is assumed that elements after the computation are stored in a logic register L3. In the present example, it is assumed that elements of the logic register L3 are stored in physical registers PA3 and PA2.

It is assumed that regions PA31 to PA35 of the physical register PA3 are used for storing elements related to a computation result. It is assumed that regions PA36 to PA38 are not used for storing elements.

On the other hand, it is assumed that elements of a non-computation portion stored in the physical register PA2 are maintained before and after computation. In other words, it is assumed that in the regions PA26 to PA28 of the physical register PA2, an element of a non-computation portion stored before computation is maintained also after computation as-stored.

In an operation example illustrated in FIG. 13, copying of an element for maintaining an element is not executed.

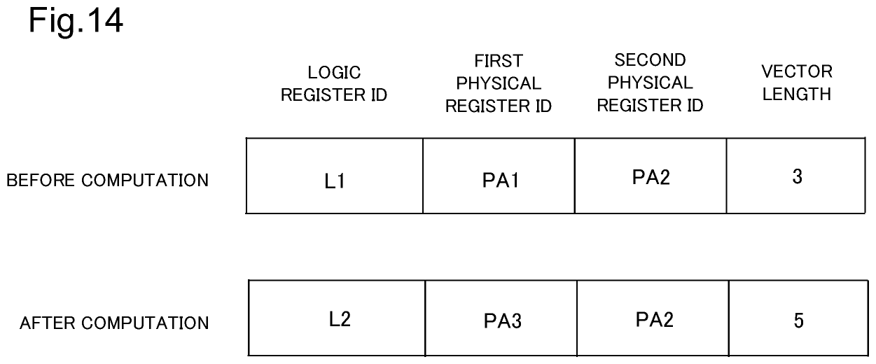

FIG. 14 is a diagram illustrating a related portion of physical register management information relevant to the operation illustrated in FIG. 13.

FIG. 14 illustrates that elements stored in the logic register L1 being a logic register storing elements before computation are stored in the physical registers PA1 and PA2. FIG. 14 further illustrates that a vector length representing the number of regions storing elements in the physical register PA1 is three.

FIG. 14 further illustrates that elements stored in a logic register L2 being a logic register storing elements after computation are stored in physical registers PA3 and PA2. FIG. 14 further illustrates that a vector length in the physical register PA3 is 5.

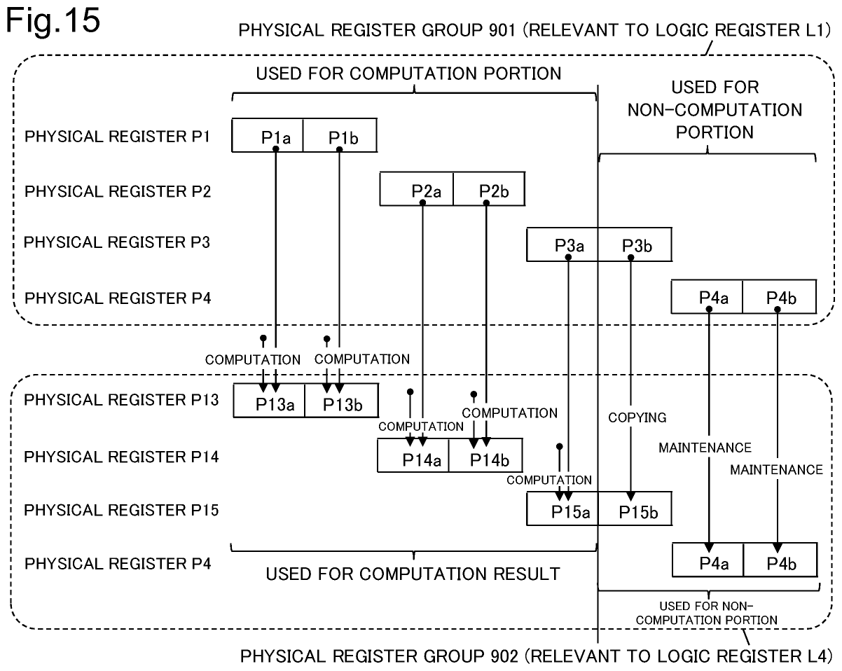

FIG. 15 is a diagram for illustrating an operation example (No. 1) related to an operation executed by the computation device 310 according to the present example embodiment, equivalent to the operation illustrated in FIG. 13. FIG. 15 illustrates an operation example in which one physical register includes two above-described regions for storing an element.

A physical register group 901 is a physical register group including physical registers storing elements stored in the logic register L1.

The physical register group 901 includes physical registers P1 to P4. Each physical register includes two regions that are a region assigned with a symbol a following a physical register ID related to the physical register and a region assigned with a symbol b following the physical register ID. These regions each can store one element.

Elements of a computation portion before computation in FIG. 13 are stored in regions of the physical register P1, regions of the physical register P2, and a region P3a of the physical register P3 illustrated in FIG. 15. The elements are equivalent to elements stored in the regions PA11 to PA13 of the physical register PA1 and the regions PA24 and PA25 of the physical register PA2 before computation.

Elements of a non-computation portion are stored in a region P3b of the physical register P3 and regions of the physical register P4 illustrated in FIG. 15. Elements of the non-computation portion are equivalent to elements stored in the regions PA26 to PA28 of the physical register PA2 illustrated in FIG. 13.

The physical register group 902 illustrated in FIG. 13 is relevant to a logic register L4 storing elements after computation.

The physical register group 902 includes physical registers P13 to p15, and P4. The physical register P4 among these is the same as the physical register P4 included in the physical register group 901 storing elements before computation.

Elements of a computation result are stored in regions of the physical register P13, regions of the physical register P14, and a region P15a of the physical register P15. The elements are elements representing a result of computation in which, on each element of computation element before computation, each element of a computation portion stored in another logic register described in description of FIG. 13 is computed. Each element of the computation portion before computation is an element stored in each of the regions of the physical register P1, the regions of the physical register P2, and the region P3a of the physical register P3 in the physical register group 901.

Elements of a non-computation portion are stored in a region P15b of the physical register P15 and regions of the physical register P4 belonging to the physical register group 902.

In order to cause elements of a non-computation portion after computation to be the same as elements of a non-computation portion before computation, an element stored in the region P3a of the physical register P3 is copied to the region P15b of the physical register P15.

In order to cause elements of a non-computation portion after computation to be the same as elements of a non-computation portion before computation, elements stored in regions of the physical register P4 are not output from the physical register and are maintained as-stored.

In the above-described operation, copying is executed once from a certain region of a physical register to a region of another physical register. Therefore, the number of times of copying is larger by one than a case where the computation device 310 executes an operation based on the literature method illustrated in FIG. 13. However, in the operation, the number of times of copying is reduced to once, which is minimum.

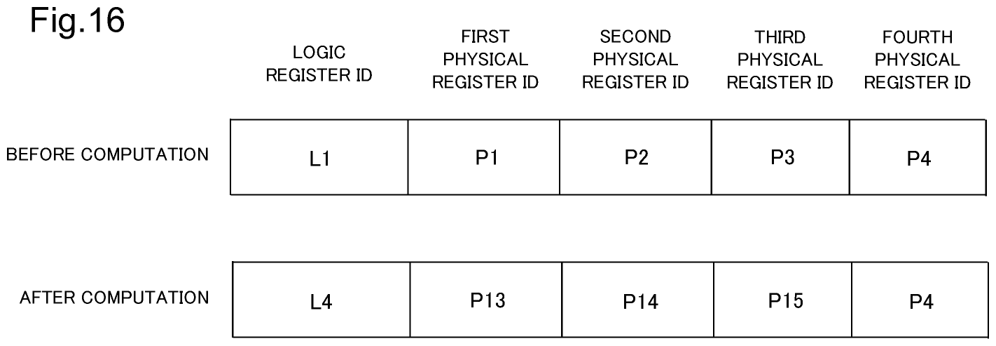

FIG. 16 is a diagram illustrating a related portion of the physical register management information relevant to the operation illustrated in FIG. 15.

The computation device 310 associates the physical registers P1 to P4 with the logic register L1 storing elements before computation.

The computation device 310 associates the physical registers P13 to P15 and the physical register P4 with the logic register L4 storing elements after computation.

The physical registers P13 to P15 store, as described with reference to FIG. 15, elements related to a computation result. Therefore, the physical registers P13 to P15 being physical registers different from the physical registers P1 to P3 storing elements before computation are secured.

On the other hand, in the physical register P4, an element related to a non-computation portion is stored also after computation.

Therefore, the physical register P4 in which a non-computation portion before computation has been stored is maintained before and after computation without changing a stored element.

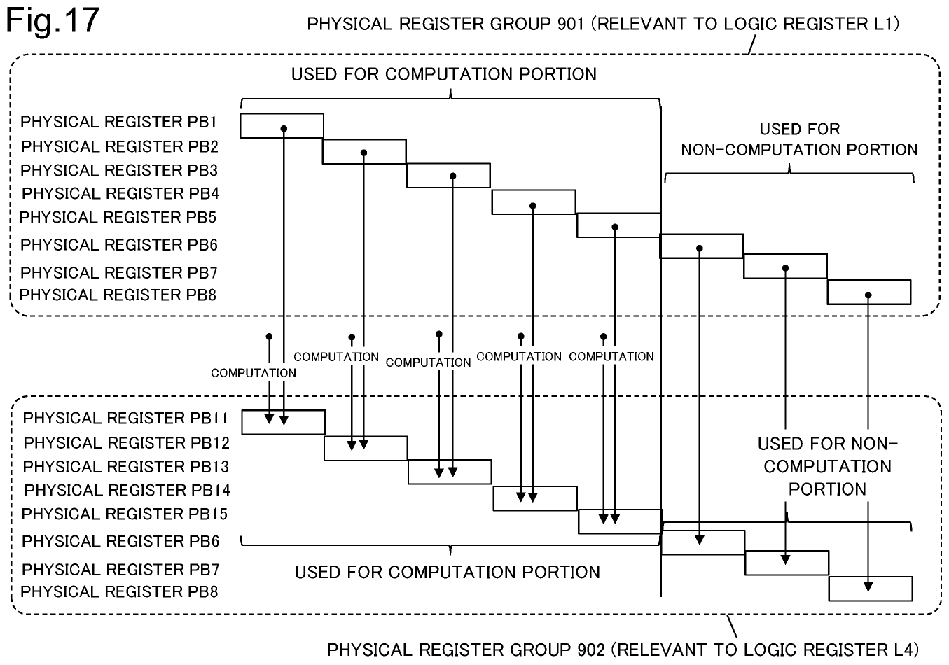

FIG. 17 is a diagram for illustrating an operation example (No. 2) according to the present example embodiment corresponding to the operation illustrated in FIG. 13. FIG. 17 illustrates an operation example in which one physical register includes one above-described region for storing an element.

A physical register group 901 is a physical register group including physical registers storing elements stored in a logic register L1.

The physical register group 901 includes physical registers PB1 to PB8. Each physical register includes one region for storing an element.

In FIG. 13, elements of a computation portion before computation are stored in the physical registers PB1 to PB5 of the physical register group 901. The elements of the computation portion before computation are equivalent to elements stored in the regions PA11 to PA13 of the physical register PA1 and the regions PA24 and PA25 of the physical register PA2.

Elements of a non-computation portion are stored in the physical registers PB6 to PB8 of the physical register group 901. The elements of the non-computation portion are equivalent to elements stored, before computation, in the regions PA26 to PA28 of the physical register PA2 illustrated in FIG. 13.

A physical register group 902 illustrated in FIG. 17 is relevant to a logic register L4 storing elements after computation.

The physical register group 902 includes physical registers PB11 to PB15 and PB6 to PB8. The physical registers PB6 to PB8 among these are the same as the physical registers PB6 to PB8 included in the physical register group 901 storing elements before computation.

The physical registers PB11 to PB15 store elements representing a computation result. Each of the elements is each element representing a result of computation executed between each element of a computation portion before computation stored in each of the physical registers PB1 to PB5 of the physical register group 901 and each element of a computation portion stored in another logic register described in description of FIG. 13.

The physical registers PB6 to PB8 belonging to the physical register group 902 store elements of a non-computation portion.

In order to cause elements of a non-computation portion after computation to be the same as elements of a non-computation portion before computation, elements stored in the physical registers PB6 to PB8 of the physical register group 901 are not output from the physical registers and are maintained also after computation as-stored.

In the above-described operation, copying from a certain region of a physical register to a region of another physical register for maintaining an element is not executed.

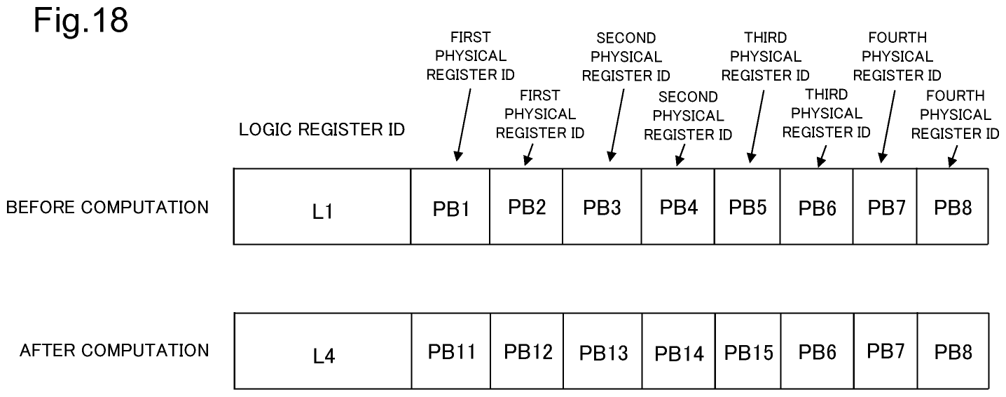

FIG. 18 is a diagram illustrating a related portion of the physical register management information relevant to the operation illustrated in FIG. 17.

The computation device 310 associates the physical registers PB1 to PB8 with the logic register L1 storing elements before computation.

The computation device 310 associates the physical registers PB11 to PB15 and PB6 to PB8 with the logic register L4 storing elements after computation.

The physical registers PB11 to PB15 store elements related to a computation result as described with reference to FIG. 17. Therefore, the physical registers PB11 to PB15 being physical registers different from the physical registers PB1 to PB5 in which elements before computation have been stored are secured.

On the other hand, the physical registers PB6 to PB8 store elements related to a non-computation portion also after computation. Therefore, the physical registers PB6 to PB8 in which a non-computation portion before computation has been stored are maintained before and after computation without changing stored elements.

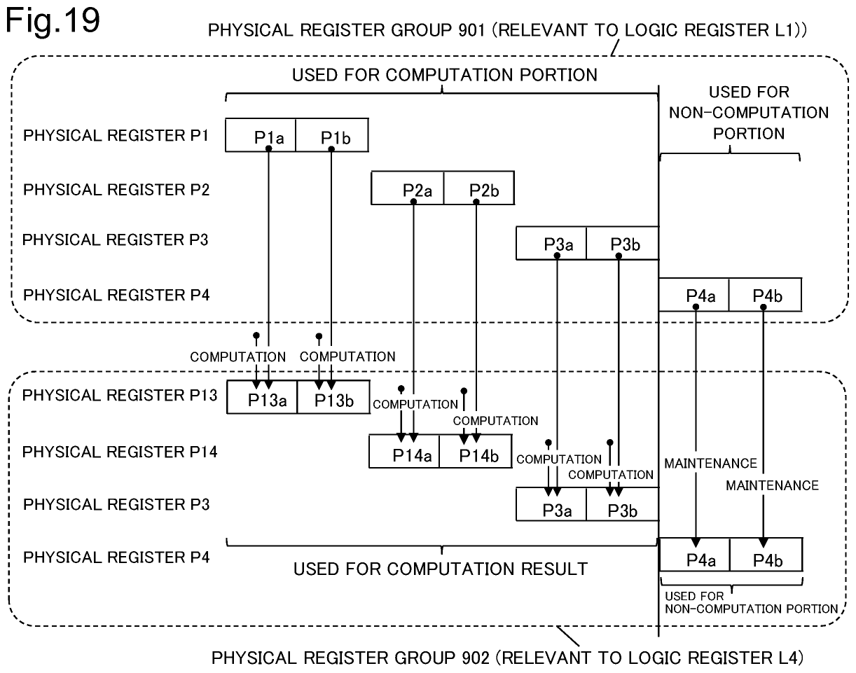

FIG. 19 is a diagram for illustrating an operation example (No. 1) in which the computation device 310 according to the present example embodiment executes computation where a vector length is six. FIG. 19 illustrates an operation example in which two regions are included in one physical register.

A physical register group 901 includes physical registers storing elements stored in a logic register L1.

The physical register group 901 includes physical registers P1 to P4. Each physical register includes two regions that are a region assigned with a symbol a following a physical register ID related to the physical register and a region assigned with a symbol b following the physical register ID. These regions each can store one element.

Elements of a computation portion before computation stored in the logic register L1 are stored in regions of the physical registers P1, P2, and P3 of the physical register group 901.

Elements of a non-computation portion stored in the logic register L1 are stored in regions of the physical register P4. It is assumed that these elements of the non-computation portion are elements to be maintained also after computation.

A physical register group 902 illustrated in FIG. 19 is relevant to a logic register L4 being a logic register storing elements after computation.

The physical register group 902 includes physical registers P13, P14, P15, and P4. The physical register P4 among these is the same as the physical register P4 included in the physical register group 901 storing elements before computation.

Regions of the physical registers P13, P14, and P15 store elements as a computation result. Each of the elements represents a result of computation executed between each element of a computation portion stored in each of the regions of the physical registers P1, P2, and P3 of the physical register group 901 and each element of a computation portion stored in another logic register in which a vector length is six.

Regions of the physical register P4 belonging to the physical register group 902 store elements of a non-computation portion. In order to cause elements of a non-computation portion after computation to be the same as elements of a non-computation portion before computation, elements stored in the regions of the physical register P4 are not output from the physical register and are maintained as-stored.

In the above-described operation, copying from a certain region of a physical register to a region of another physical register for maintaining an element is not executed.

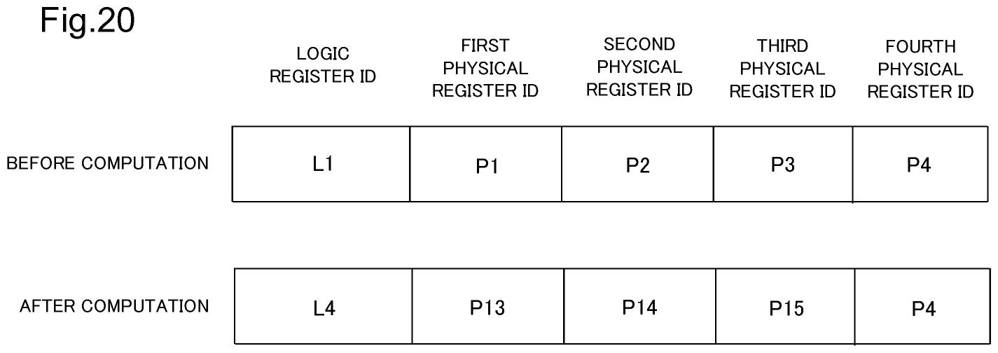

FIG. 20 is a diagram illustrating a related portion of the physical register management information relevant to the operation illustrated in FIG. 19.

The computation device 310 associates the physical registers P1 to P4 with the logic register L1 storing elements before computation.

The computation device 310 associates the physical registers P13 to P15 and the physical register P4 with the logic register L4 storing elements after computation.

The physical register P13 to P15 store elements related to a computation result as described with reference to FIG. 19. Therefore, the physical register P13 to P15 being physical registers different from the physical registers P1 to P3 in which elements before computation have been stored are secured.

On the other hand, the physical register P4 stores an element related to a non-computation portion also after computation. Therefore, the physical register P4 in which a non-computation portion has been stored before computation is maintained before and after computation without changing a stored element.

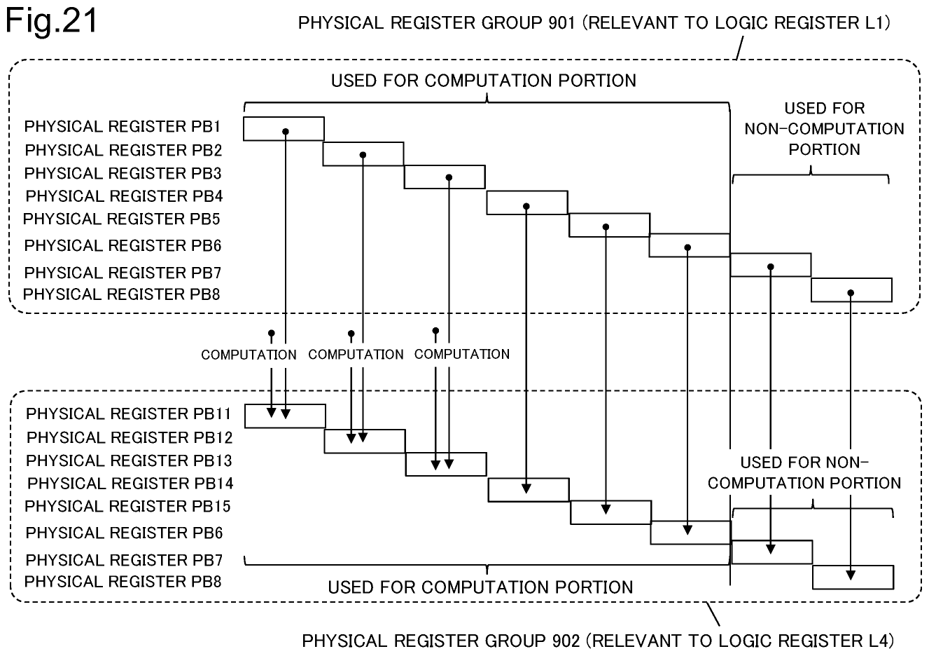

FIG. 21 is a diagram for illustrating an operation example (No. 2) according to the present example embodiment in which computation where a vector length is six is executed. FIG. 21 illustrates an operation example in which one physical register includes one region for storing an element.

A physical register group 901 includes physical registers storing elements stored in a logic register L1.

The physical register group 901 includes physical registers PB1 to PB8. Each physical register includes one region for storing an element.

Elements of a computation portion stored in the logic register L1 are stored in the physical register PB1 to PB5 of the physical register group 901. Elements of a non-computation portion stored in the logic register L1 are stored in the physical register PB6 to PB8 of the physical register group 901. It is assumed that these elements of the non-computation portion are elements to be maintained also after computation.

A physical register group 902 is relevant to a physical register L4 storing elements after computation.

The physical register group 902 includes physical registers PB11 to PB16, PB7, and PB8. The physical registers PB7 and PB8 among these are the same as the physical registers PB7 and PB8 included in the physical register group 901 storing elements before computation.

The physical register PB11 to PB16 store elements of a computation result. Each of the elements is each element representing a result of computation executed between each element of a computation portion before computation stored in each of the physical registers PB1 to PB6 included in the physical register group 901 and each element of a computation portion before computation stored in another logic register.

The physical register PB7 and PB8 belonging to the physical register group 902 store elements of a non-computation portion.

In order to cause elements of a non-computation portion after computation to be the same as elements of a non-computation portion before computation, elements stored in the physical registers PB7 and PB8 of the physical register group are not output from the physical registers and are maintained as-stored.

In the operation, copying from a physical register to another physical register for maintaining an element is not executed.

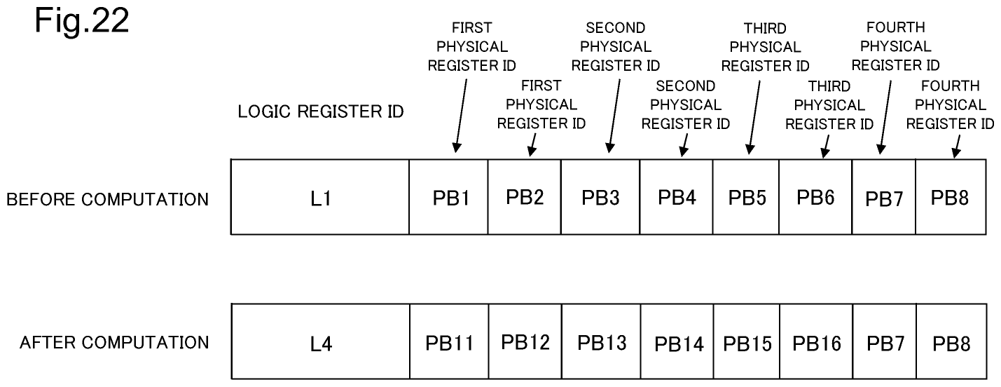

FIG. 22 is a diagram illustrating a related portion of the physical register management information relevant to the operation illustrated in FIG. 21.

The computation device 310 associates the physical registers PB1 to PB8 with the logic register L1 storing elements before computation.

The computation device 310 further associates the physical registers PB11 to PB16, PB7, and PB8 with the logic register L4 storing elements after computation.

The physical registers PB11 to PB16 store elements related to a computation result, as described with reference to FIG. 21. Therefore, the physical registers PB11 to PB16 being physical registers different from the physical registers PB1 to PB6 in which elements before computation have been stored are secured.

On the other hand, the physical registers PB7 and PB8 store elements related to a non-computation portion also after computation. Therefore, elements stored in the physical registers PB7 and PB8 in which a non-computation portion before computation has been stored are not changed and are maintained before and after computation.

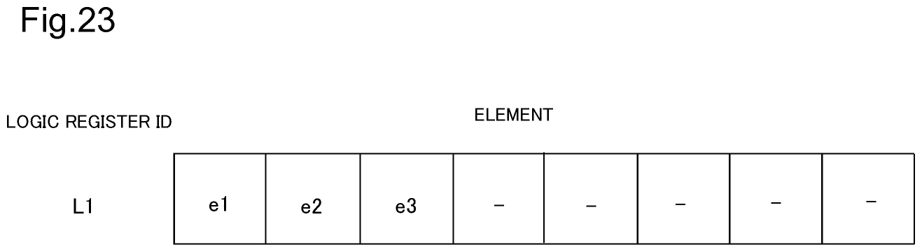

Next, with reference to FIG. 23 to FIG. 25, it is described that a region belonging to a physical register is effectively used according to an operation of the present example embodiment, compared with a case based on the literature method.

FIG. 23 is a diagram illustrating an example of a related portion of the above-described logic register management information in the literature method.

In the example illustrated in FIG. 23, a logic register L1 stores three elements that are elements e1 to e3.

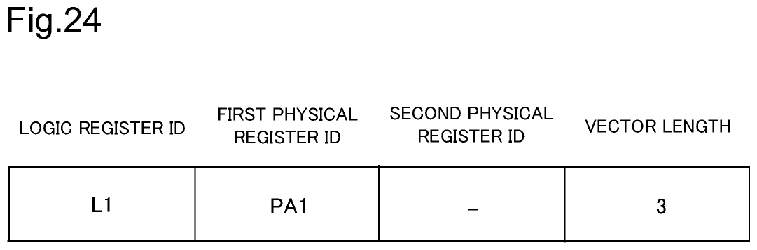

FIG. 24 is a diagram illustrating an example of a related portion of the above-described physical register management information relating to the logic register L1 illustrated in FIG. 23 in the literature method.

The computation device 310 associates a physical register PA1 with the logic register L1. The computation device 310 further causes a vector length indicating the number of regions storing an element in the physical register PA1 to be three.

In the literature method, as described above, the number of regions of one physical register is equal to the number of elements stored in a logic register. Therefore, in this case, the number of regions of one physical register is eight. Therefore, five regions among eight regions of the physical register PA1 are unused regions that do not store an element. These unused regions in the physical register PA1 are allocated to the logic register L1 by being included in the physical register PA1, and therefore it is difficult to appropriate these unused regions for another processing step. Therefore, these unused regions are regions uselessly secured in order to store an element stored in the logic register L1.

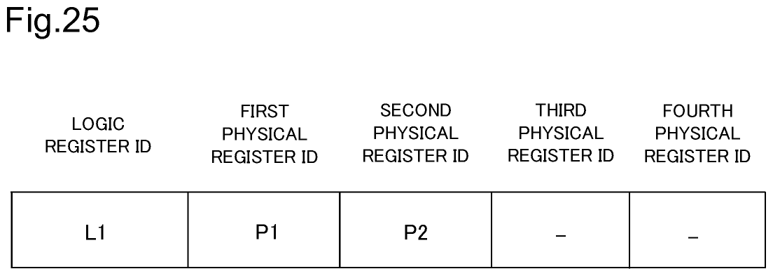

FIG. 25 is a diagram illustrating a related portion of physical register management information according to the present example embodiment corresponding to a portion of the logic register management information illustrated in FIG. 23.

The computation device 310 allocates the physical registers P1 and P2 to the logic register L1. As described above, a physical register includes two regions. Therefore, among regions of a physical register allocated to a logic register, if any, there is only one register that is not used for storing an element.

Therefore, according to the present example embodiment, when the number of elements stored in one logic register is small (a vector length is short) compared with the literature method, a region included in a physical register can be effectively used, compared with the literature method.

According to the computation device of the present example embodiment, generation of a region uselessly secured can be reduced, as described above. According to the computation device of the present example embodiment, when the number of regions included one physical register is two, the number of useless regions can be one or zero. According to the computation device of the present example embodiment, when the number of regions included in one physical register is one, the number of useless regions can be zero.

In this manner, according to the computation device of the present example embodiment, an amount of copying for maintaining an element can be reduced, and in addition, a region included in a physical register can be more efficiently used.

When a predetermined physical register is not referred to in a vector instruction for execution of computation, information after computation related to the computation can be stored even when the physical register is a physical register storing information before computation. When such processing is executed, an element stored before computation is maintained and thereby it is unnecessary to execute copying of the element. Therefore, the processing is commonly executed in order to reduce the number of times of copying.

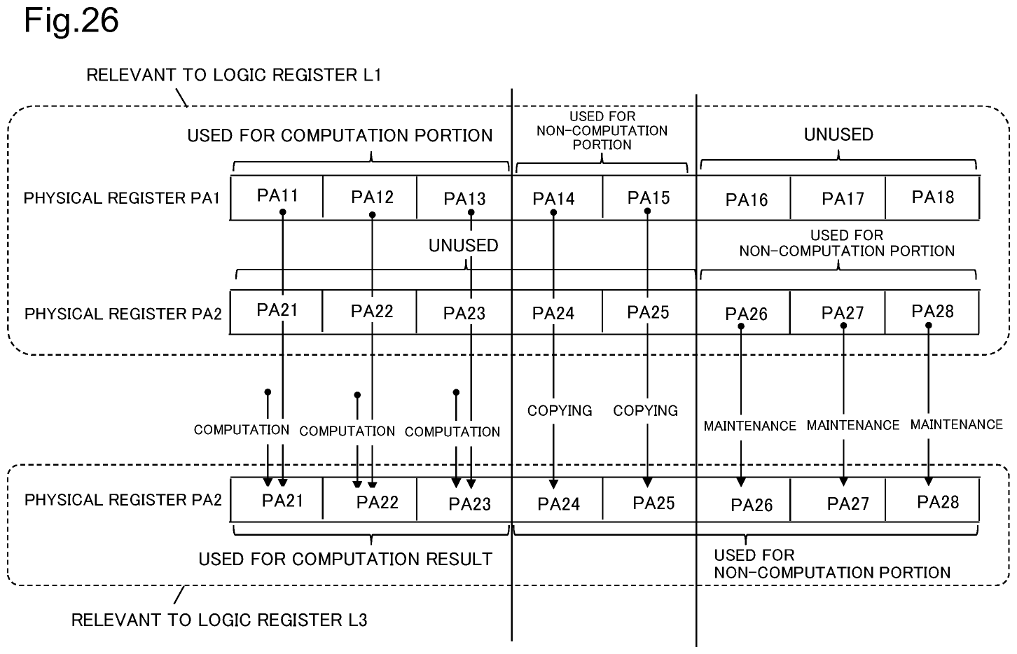

FIG. 26 is a diagram for illustrating an operation example based on the literature method, where the computation device 310 stores an element after computation in a physical register that is not referred to in a vector instruction for storing an element before computation in a physical register.

In the present example, the computation device 310 allocates physical registers PA1 and PA2 to a logic register L1 storing elements before computation.

In the present example, the computation device 310 stores elements of a computation portion used for computation in regions PA11 to PA13 of the physical register PAL The computation device 310 stores elements of a non-computation portion that are not used for computation in regions PA14 and PA15 of the physical register PA1. It is assumed that these elements of the non-computation portion are elements to be maintained also after computation. The computation device 310 does not use regions PA16 to PA18 of the physical register PA1 in order to store an element.

In the present example, the computation device 310 does not use regions PA21 to PA25 of the physical register PA2 to store an element. The computation device 310 uses regions PA26 to PA28 of the physical register PA2 to store elements of a non-computation portion. It is assumed that these elements of the non-computation portion are elements to be maintained also after computation.

In the present example, the computation device 310 further stores, in a logic register L3, elements after computation in which a vector length is three executed for an element stored in the logic register L1. The computation device 310 associates the physical register PA2 with the logic register L3. The computation device 310 executes the association since the above-described reference number information indicates that the physical register PA2 is not referred to in a vector instruction for computation.

The computation device 310 stores elements after computation in the regions PA21 to PA23 of the physical register PA2. The computation device 310 further copies elements of a non-computation portion stored in the regions PA14 and PA15 of the physical register PA1 to the regions PA24 and PA25 of the physical register PA2. The computation device 310 further maintains elements stored in the regions PA26 to PA28 of the physical register PA2.

In the above-described operation, elements stored in the regions PA26 to PA28 of the physical register PA2 are maintained before and after computation, and therefore copying of these elements for maintaining an element are not executed. Therefore, the number of executions of copying is reduced to two. However, also in the above-described method, copying for maintaining an element is required twice.

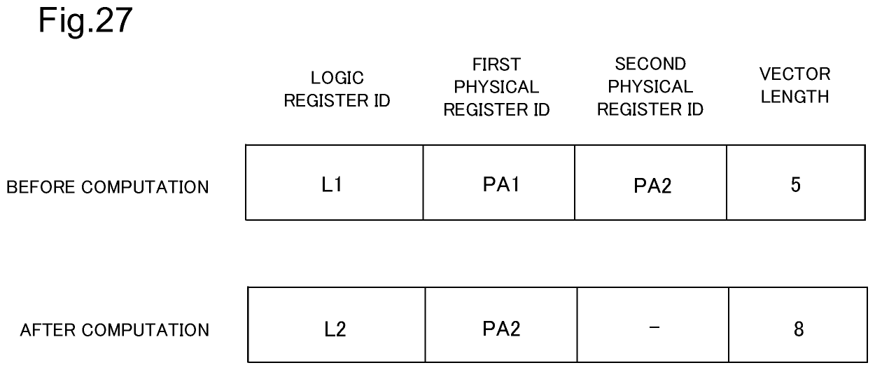

FIG. 27 is a diagram illustrating a related portion of physical register management information relevant to the operation illustrated in FIG. 26.

In FIG. 27, the logic register L1 storing elements before computation is associated with the physical registers PA1 and PA2. A vector length for storing elements in the physical register PA1 is five.

The logic register L2 storing elements after computation is associated with the physical register PA2. A vector length for storing elements in the physical register PA2 after computation is eight.

An operation example in which an operation equivalent to the operation illustrated in FIG. 26 is executed by the computation device 310 according to the present example embodiment is the above-described operation illustrated in FIG. 9. Physical registers P1 and P2 store elements before computation and therefore are referred to by a vector instruction for storing an element before computation in a physical register in the above-described reference number information.

Therefore, the reason is that it is necessary to use, in order to store elements after computation, for example, physical registers P13 and P14 being physical registers other than the physical register P1 and P2.

The number of times of copying necessary for the computation device 310 to maintain an element in the case illustrated in FIG. 9 is one as described above and is less than two in the case of the operation example illustrated in FIG. 26.

### Advantageous Effects

According to the computation device according to the present example embodiment, each physical register includes two or less regions for simultaneously storing information elements.

When each physical register includes two regions, the computation device executes copying for maintaining an information element when one of the two regions included in the physical register stores an element relating to computation and the other stores an element not relating to computation. Therefore, the computation device can cause, in this case, the number of times of copying for maintaining an element executed in computation of one time to be one or less.

When each physical register includes only one region, it is unnecessary to execute copying for maintaining an element.

In contrast, in the method described in PTL 5, as described above, copying for maintaining an information element may be executed twice or more in computation of one time.

In other words, according to the computation device of the present example embodiment, the number of times of copying necessary for maintaining an information element in computation of one time can be reduced.

Herein, when the number of times of copying executable in computation of one time is large, it is necessary to install, in a computation device, in addition to a port for executing computation, an extra port for executing copying by the number of times of copying that may be executed in computation of one time. According to the computation device of the present example embodiment, the number of times of copying for maintaining an element necessary in computation of one time can be reduced, and therefore the number of ports for copying can be reduced.

When each physical register includes two regions, the number of physical registers relevant to one logic register is reduced to half, compared with a case where one region is provided. Therefore, in the case, also with regard to physical register management information, the number of physical register IDs relevant to each logic register ID is reduced to half. Therefore, in the case, there is an advantage that a size of physical register management information is small and less processing for referring to physical register management information performed by a renaming processing unit is required.

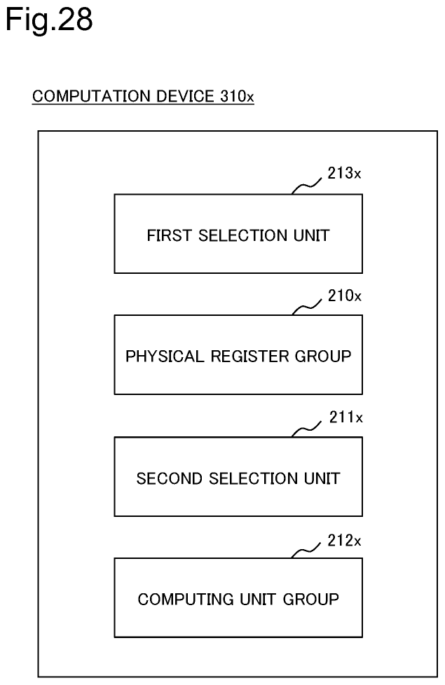

FIG. 28 is a block diagram illustrating a configuration of a computation device 310x which is a minimum configuration of the computation device according to the example embodiment.

The computation device 310x includes a first selection unit 213x, a physical register group 210x, a second selection unit 211x, and a computing unit group 212x.

The first selection unit 213x inputs, to each physical register selected based on first control information, each of the information elements having the vector length of the first element group and each of the information elements having the vector length of the second element group. The physical register is included in the physical register group 210x.

The physical register group 210x includes the physical register storing each of the information elements input from the first selection unit 213x.

The second selection unit 211x inputs, to each input unit of a predetermined computing unit included in the computing unit group 212x, each of the information elements input from each of the physical registers storing the information elements input from the first selection unit 213x.

The computing unit group 212x outputs the third element group, based on the vector computation related to the information elements input from the second selection unit 211x.

The physical register selected based on the first control information may be different between a first physical register and a second physical register. Herein, the first physical register stores each of the information elements being the vector computation target before predetermined vector computation. The second physical register stores the information element related to a computation result of the vector computation for the information element.

The number of regions, capable of simultaneously storing the information elements, included in each of the physical registers is two or less.

When each physical register includes two regions, the computation device executes copying necessary for maintaining an information element in the following case. The case is, in other words, a case where either of two regions included in a physical register stores the information element relating to computation and the other stores the information element not relating to computation. Therefore, the number of times of copying of the information element required in computation of one time is one or less.

When each physical register includes only one region, it is unnecessary to execute copying for maintaining the information element.

On the other hand, in the method described in PTL 5, as described, in computation of one time, copying may be executed twice or more.

Therefore, the computation device 310x can reduce the number of times of copying for maintaining an information element executable in computation of one time.

Therefore, the computation device 310x produces, by including the above-described configuration, an advantageous effect described in the section of Advantageous Effects of Invention.

The computation device 310x illustrated in FIG. 28 is, for example, the computation device 310 illustrated in FIG. 1 or FIG. 2. The first selection unit 213x is, for example, the write selection unit 213 illustrated in FIG. 1 or FIG. 2. The physical register group 210x is, for example, the physical register group 210 illustrated in FIG. 1 or FIG. 2. The second selection unit 211x is, for example, the read selection unit 211 illustrated in FIG. 1 or FIG. 2. The computing unit group 212x is, for example, the computing unit group 212 illustrated in FIG. 1 or FIG. 2.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-118772, filed on Jun. 22, 2018, the disclosure of which is incorporated herein in its entirety by reference.

### REFERENCE SIGNS LIST

100 Control unit
110 Instruction supply unit
111 Instruction issuing control unit
112 Renaming control unit
113 Execution control unit
121 Storage unit
200 Computation unit
210, 210x Physical register group
211 Read selection unit
211x Second selection unit
212, 212x Computing unit group
213 Write selection unit
213x First selection unit
291, 292, 293, 294, 295, 296, 297 Port group
310, 310x Computation device
320 Storage device
400 Physical register management information
401 Logic register management information
402 Reference number information
500 Computation system

What is claimed is:

1. A computation device storing, in a third logic register, a third element group that includes information elements, stored in a logic register, representing a computation result of vector computation between the information elements having a predetermined vector length among a first element group including the information elements stored in a first logic register, and the information elements having the vector length among a second element group including the information elements stored in a second logic register, the computation device comprising:
a first selection unit configured to input each of the information elements having the vector length among the first element group and each of the information elements having the vector length among the second element group to each of physical registers selected based on first control information, the physical registers being included in a physical register group;
the physical register group including the physical registers each storing each of the information elements input from the first selection unit;
a second selection unit configured to input each of the information elements input from each of the physical registers storing the information elements input from the first selection unit to each input unit of computing units included in a computing unit group; and
the computing unit group outputting the third element group, based on the vector computation for the information elements input from the second selection unit, wherein
the physical register selected based on the first control information is different, depending on a case, between the physical register storing each of the information elements being a target for vector computation before the vector computation and the physical register storing the information elements representing a computation result of the vector computation for the information elements, and
a number of regions, included in each of the physical registers, being able to simultaneously store the information elements is two or less.

2. The computation device according to claim 1, wherein a number of the regions is one.

3. The computation device according to claim 1, wherein numbers of the information elements which can be stored in the logic register, the second logic register, and the third logic register are same as each other.

4. The computation device according to claim 1, further comprising: an input port group including input ports for input, to the physical registers, of the information elements a number of which is larger than a number of the provided physical registers; and a first connection unit configured to connect a predetermined port of the input port group to an input terminal of the predetermined physical register.

5. The computation device according to claim 1, further comprising a second connection unit configured to connect output from the physical register to an input port of each computing unit of the computing unit group or wiring for copying.

6. The computation device according to claim 1, storing physical register management information being information representing the physical register storing the information element stored in each of the logic registers and storing, based on the physical register management information, the information element in the physical register.

7. A computation device comprising: the computation device according to claim 5; and a storage device being able to store output from each of the computing units and the wiring.

8. The computation device according to claim 1, wherein at least either of the information element that is not the information element having the vector length among the information elements stored in the first logic register and the information element that is not the information element having the vector length among the information elements stored in the second logic register is stored in the third logic register.
